(19) United States
(12) Patent Application Publication
(10) Pub. No.: US 2015/0037667 A1
(43) Pub. Date: Feb. 5, 2015

(54) NONAQUEOUS ELECTROLYTE SOLUTION AND SECONDARY BATTERY USING SAME

(71) Applicant: NEC Corporation, Tokyo (JP)

(72) Inventors: Masahiro Suguro, Tokyo (JP); Midori Shimura, Tokyo (JP)

(21) Appl. No.: 14/374,961

(22) PCT Filed: Jan. 23, 2013
(86) PCT No.: PCT/JP2013/051351

§ 371 Date: Jul. 28, 2014

(30) Foreign Application Priority Data
Jan. 30, 2012 (JP) 2012-017361

(51) Int. Cl. H01M 10/0567; H01M 4/133; H01M 4/38; H01M 4/48; H01M 4/583; H01M 4/134; H01M 4/36

(52) U.S. Cl. CPC H01M 10/0567; H01M 4/134; H01M 4/133; H01M 4/364; H01M 4/48; H01M 4/583; H01M 4/386; H01M 2004/027
USPC 429/200; 429/188

(57) ABSTRACT

Disclosed is a nonaqueous electrolyte solution containing a nonaqueous solvent, an electrolyte salt dissolved in the nonaqueous solvent, and a conjugated carbonyl compound represented by the following formula (1). A secondary battery using this nonaqueous electrolyte solution shows an excellent cycle characteristic under a high-temperature environment even if a negative electrode active material containing silicon is used.

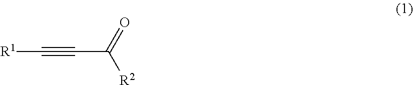

wherein R¹ represents R^{2a} or —CO—R^{2a}, R^{2a} having a meaning given to R², and R² represents a hydrogen atom, an acyl group, an alkyl group, a cycloalkyl group, an alkenyl group, an alkynyl group, a substituted or unsubstituted aromatic group, an oxyalkylene group, an alkoxy group, a cycloalkyloxy group, an alkenyloxy group, an alkynyloxy group, an aromatic oxy group, an oxyalkyleneoxy group or the like.

### TECHNICAL FIELD

The present invention relates to a nonaqueous electrolyte solution for a secondary battery, and more particularly, it relates to a nonaqueous electrolyte solution suitably used for a lithium ion secondary battery using a negative electrode containing silicon.

### BACKGROUND ART

Nonaqueous electrolyte secondary batteries such as lithium ion secondary batteries have been already put to practical use as batteries for laptop computers, cellular phones and the like because of their advantages of high energy density, small self-discharge, excellent long-term reliability and the like. In recent years, however, electronic devices are more sophisticated and more largely used in electric vehicles, and therefore, there is a demand for development of a lithium ion secondary battery having a higher energy density.

In such a nonaqueous electrolyte secondary battery, a chemical reaction or decomposition of an electrolyte layer may occur on an electrode surface of a positive electrode and/or a negative electrode. As a result, there arise problems of degradation in the storage characteristic of a battery at a high temperature, degradation of the cycle characteristic of a secondary battery, and generation of a gas from a decomposition product. In order to prevent these problems, a compound having a function to form a protective coating is added to an electrolyte solution contained in an electrolyte layer. Specifically, it is known that when decomposition of the compound added to the electrolyte solution is intentionally accelerated on the surface of a negative electrode active material at the time of initial charge, the thus generated decomposition product forms a protective coating having a protective function, namely, an SEI (Solid Electrolyte Interface), to prevent decomposition of the resulting electrolyte layer. It has been reported that when the protective coating is thus formed, the chemical reaction or decomposition of the electrolyte layer otherwise occurring on the surface of the negative electrode can be suitably suppressed, and that as a result, an effect to retain the battery performance of the secondary battery is exhibited.

As an additive for forming a protective coating, use of an oxygen-containing aliphatic compound having an alkynyl group (Patent Literature 1), acetylene dicarboxylic ester (Patent Literature 2), acetylene dicarboxylic diester, vinylene carbonate and propane sultone (Patent Literature 3), or LiBF₄ and acetylene dicarboxylic diester (Patent Literature 4) has been disclosed.

Besides, conventional graphite negative electrode materials have such insufficient capacities that demanded performances are difficult to attain. Therefore, investigation utilizing a metal negative electrode material having a high capacity and a high energy density, such as silicon or tin as a negative electrode active material have also been made (Patent Literature 5).

### CITATION LIST

### Patent Literature

Patent Literature 1: Japanese Patent No. 4093699
Patent Literature 2: Japanese Patent Laid-Open No. 2003-059532
Patent Literature 3: WO2005/122318
Patent Literature 4: Japanese Patent Laid-Open No. 2008-251212
Patent Literature 5: Japanese Patent Laid-Open No. 6-325765

### SUMMARY OF INVENTION

### Technical Problem

As described above, Patent Literature 5 discloses a secondary battery using a negative electrode active material containing silicon, and a negative electrode containing silicon has an advantage of a high energy density. If a secondary battery using a negative electrode active material containing silicon is charged and discharged at 45° C. or more, however, there are cases where the capacity with the charge/discharge cycles reduces extremely largely. In particular, a laminated type lithium ion secondary battery using simple silicon or a silicon oxide as a negative electrode active material may be expanded in some cases if it is charged/discharged under a high-temperature environment, and thus, there is a problem of degradation of the cycle characteristic.

As described in Patent Literatures 1 to 4, attempts have been made to improve the cycle characteristic of a secondary battery by including an additive in an electrolyte solution. While investigations are being intensively made on an additive to be used in a graphite negative electrode (carbon negative electrode), many investigations are not made on an alloy negative electrode using silicon, tin or the like, and such a negative electrode has not attained sufficient stability. Therefore, there is a demand for elongation of the lifetime of a secondary battery using a negative electrode active material containing silicon.

Accordingly, an object of the present invention is to provide a nonaqueous electrolyte solution for a secondary battery that shows an excellent cycle characteristic under a high-temperature environment when used in a secondary battery, particularly a secondary battery using a negative electrode active material containing silicon, and a secondary battery using the same.

### Solution to Problem

The present inventor has found, as a result of earnest studies, that the aforementioned problems can be solved by adding, to an electrolyte solution, a specific organic compound that has not been used as an electrode active material, namely, a compound having, in a molecule, a moiety represented by the following formula (1).

The present invention relates to a nonaqueous electrolyte solution for a lithium secondary battery using a negative electrode active material containing element silicon, and the nonaqueous electrolyte solution contains a nonaqueous solvent, an electrolyte salt dissolved in the nonaqueous solvent, and a conjugated carbonyl compound represented by the following formula (1) and contained in a percentage of 0.01 to 4 wt % in the nonaqueous electrolyte solution.

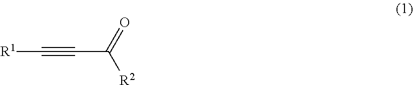

wherein

R¹ represents R^{2a} or —CO—R^{2a}, R^{2a} having a meaning given for R², and

R² represents a hydrogen atom, a substituted or unsubstituted acyl group, a substituted or unsubstituted alkyl group, a cycloalkyl group, an alkenyl group, an alkynyl group, a substituted or unsubstituted aromatic group, an oxyalkylene group represented by the following formula (2):

—(R²¹O)ₙ—R²² (2)

wherein R²¹ represents alkylene having 1 to 6 carbon atoms, R²² represents a hydrocarbon group having 1 to 12 carbon atoms, and n represents an integer of 1 to 10,

an unsubstituted alkoxy group, a substituted alkoxy group, a cycloalkyloxy group, an alkenyloxy group, an alkynyloxy group, a substituted or unsubstituted aromatic oxy group, or an oxyalkyleneoxy group represented by the following formula (2b):

—O—(R²¹O)ₙ—R²² (2b)

wherein R²¹ represents alkylene having 1 to 6 carbon atoms, R²² represents a hydrocarbon group having 1 to 12 carbon atoms, and n represents an integer of 1 to 10.

### Advantageous Effects of Invention

According to an embodiment of the present invention, a secondary battery using a negative electrode active material containing silicon that is excellent in a cycle characteristic in terms of expansion and capacity retention under a high-temperature environment can be provided.

### BRIEF DESCRIPTION OF DRAWINGS

FIG. 1 is a schematic cross-sectional view illustrating the structure of an electrode element used in a laminated type secondary battery.

### DESCRIPTION OF EMBODIMENTS

It is presumed that a conjugated carbonyl compound represented by formula (1) is reduced on the surface of a negative electrode in a charging process to give a product as represented by the following scheme (I). The resulting reductant is deposited on the surface of the negative electrode to form a coating (electrode protective film). Since the conjugated carbonyl compound represented by formula (1) of the present invention is more highly reactive than carbonates used as an electrolyte solvent, the compound reductively decomposes priorly to a reductive decomposition of the carbonates on the surface of the negative electrode to form the coating, and hence, excessive decomposition of the electrolyte solvent can be inhibited. Besides, the resulting product represented in the following scheme has high lithium ion conductivity, and hence does not lower the charge/discharge speed (the charge/discharge rate characteristic). Furthermore, since a polymer (organic polymer) is formed partially in the coating formed by the conjugated carbonyl compound represented by formula (1) forms, a strong coating is formed.

In other words, the present invention was established on the basis of finding that a coating formed from a conjugated ester compound represented by formula (1) has high lithium ion conductivity and a strong composition that cannot be broken through the charge/discharge cycle of an active material.

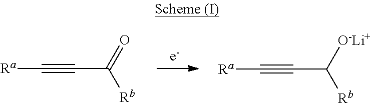

Now, the nonaqueous electrolyte solution of the present invention and an example of a secondary battery capable of using the nonaqueous electrolyte solution will be described with respect to individual elements thereof.

### [1] Negative Electrode

A negative electrode is prepared by, for example, binding a negative electrode active material to a negative electrode collector with a binder for negative electrode.

In one embodiment of the present invention, the negative electrode active material preferably contains the element silicon. Examples of the negative electrode active material containing the element silicon include silicon and a silicon compound. An example of the silicon includes simple silicon. Examples of the silicon compound include silicon oxides, silicates, and compounds containing a transition metal and silicon, such as nickel silicide or cobalt silicide. A silicon compound has a function to relax expansion and contraction of the negative electrode active material itself in repeating the charge/discharge cycle, and is preferably used from the viewpoint of the charge/discharge cycle characteristic. Besides, some types of silicon compounds have a function to secure connection between silicon portions, and from this point of view, a silicon oxide is preferably used as the silicon compound.

The silicon oxide is not especially limited, but a silicon oxide represented by, for example, SiOₓ (0<x≦2) may contain Li and the silicon oxide containing Li is represented by, for example, SiLi_{y}Oₓ (y>0 and 2>z>0). Besides, the silicon oxide may contain a slight amount of a metallic element or a nonmetallic element. The silicon oxide may contain one, two or more elements selected from the group consisting of, for example, nitrogen, boron and sulfur in a concentration of, for example, 0.1 to 5% by mass. If a slight amount of a metallic element or a nonmetallic element is contained, the electric conductivity of the silicon oxide can be improved. The silicon oxide may be crystalline or amorphous.

The negative electrode active material preferably contains, in addition to the silicon or the silicon oxide, a carbon material capable of intercalating and deintercalating lithium ions. The carbon material may be contained in a composite state with the silicon or the silicon oxide. The carbon material has, similarly to the silicon oxide, functions to relax the expansion and contraction of the negative electrode active material itself in repeating the charge/discharge cycle, and to secure the connection between silicon portions of the negative electrode active material. Accordingly, if the silicon, the silicon oxide and the carbon material are used together, a better cycle characteristic can be attained.

As the carbon material, graphite, amorphous carbon, diamond-like carbon, a carbon nanotube, or a complex of these materials can be used. Here, graphite with high crystallinity has high electric conductivity and is excellent in adhesion to a negative electrode collector made of a metal such as copper and in voltage flatness. On the other hand, amorphous carbon with low crystallinity shows comparatively small volume expansion and hence attains a high effect to relax the volume expansion of the whole negative electrode, and degradation derived from ununiformity such as a grain boundary or a defect is difficult to occur therein. The content of the carbon material in the negative electrode active material is preferably 2% by mass or more and 50% by mass or less, and more preferably 2% by mass or more and 30% by mass or less.

As a method for preparing the negative electrode active material containing the silicon and the silicon compound, if, for example, a silicon oxide is used as the silicon compound, a method including mixing simple silicon with the silicon oxide and sintering the resulting mixture at a high temperature and reduced pressure may be employed. Alternatively, if a compound of a transition metal and silicon is used as the silicon compound, a method including mixing simple silicon with the transition metal and fusing the resulting mixture, or a method including coating the surface of simple silicon with the transition metal by vapor deposition or the like may be employed.

In addition to any of the aforementioned preparing methods, compositing with carbon may be employed in combination. For example, a coating layer of carbon can be formed around a nucleus of the simple silicon and the silicon oxide by a method of introducing a sintered product of a mixture of simple silicon and a silicon compound into a gaseous atmosphere of an organic compound under non-oxygen atmosphere at high-temperature, or a method of mixing a sintered product of a mixture of simple silicon and a silicon oxide with a carbon precursor resin under non-oxygen atmosphere at high-temperature. In this manner, effects to inhibit the volume expansion through the charge/discharge cycle and to further improve the cycle characteristic can be attained.

The negative electrode active material is preferably a complex containing silicon, a silicon oxide and a carbon material (hereinafter also referred to as the Si/SiO/C complex). The whole or a part of the silicon oxide preferably has an amorphous structure. A silicon oxide having an amorphous structure can inhibit the volume expansion of the carbon material or the silicon used as the other components of the negative electrode active material. This mechanism has not been clarified yet, but it is presumed that a silicon oxide having an amorphous structure somehow affects the formation of a coating on an interface between the carbon material and the electrolyte solution. In addition, it seems that an amorphous structure includes a comparatively small number of causes based on ununiformity such as a grain boundary or a defect. Incidentally, it can be confirmed by X-ray diffraction measurement (such as general XRD measurement) that the whole or a part of the silicon oxide has an amorphous structure. Specifically, if a silicon oxide does not have an amorphous structure, a peak characteristic to the silicon oxide is observed, but if the whole or a part of the silicon oxide has an amorphous structure, the peak characteristic to the silicon oxide is observed as a broad peak.

In the Si/SiO/C complex, the whole or a part of the silicon is preferably dispersed in the silicon oxide. By dispersing at least a part of the silicon in the silicon oxide, the volume expansion of the whole negative electrode can be more inhibited, and the decomposition of the electrolyte solution can be also inhibited. Incidentally, it can be confirmed by observation with a combination of a transmission electron microscope (general TEM observation) and energy dispersive X-ray spectroscopy (general EDX measurement) that the whole or a part of the silicon is dispersed in the silicon oxide. Specifically, a cross-section of a sample is observed, and the oxygen concentration in a silicon portion dispersed in the silicon oxide is measured, so as to confirm that the silicon portion is not an oxide.

In the Si/SiO/C complex, for example, the whole or a part of the silicon oxide has an amorphous structure, and the whole or a part of the silicon is dispersed in the silicon oxide. Such a Si/SiO/C complex can be prepared by, for example, a method disclosed in Japanese Patent Laid-Open No. 2004-47404. Specifically, the Si/SiO/C complex can be obtained, for example, by subjecting a silicon oxide to a CVD treatment under an atmosphere containing an organic gas such as a methane gas. The Si/SiO/C complex obtained by this method is in such a form that surfaces of particles of the silicon oxide containing silicon are coated with carbon. In addition, the silicon is present in the form of nanoclusters in the silicon oxide.

In the Si/SiO/C complex, the ratio among the silicon, the silicon oxide and the carbon material is not especially limited. The silicon is contained in the Si/SiO/C complex in a percentage of preferably 5% by mass or more and 90% by mass or less, and more preferably 20% by mass or more and 50% by mass or less. The silicon oxide is contained in the Si/SiO/C complex in a percentage of preferably 5% by mass or more and 90% by mass or less, and more preferably 40% by mass or more and 70% by mass or less. The carbon material is contained in the Si/SiO/C complex in a percentage of preferably 2% by mass or more and 50% by mass or less, and more preferably 2% by mass or more and 30% by mass or less.

Furthermore, the Si/SiO/C complex may be a mixture of simple silicon, a silicon oxide and a carbon material, and can be prepared also by mixing simple silicon, a silicon oxide and a carbon material by using a mechanical milling. For example, the Si/SiO/C complex can be obtained by mixing simple silicon, a silicon oxide and a carbon material all in the form of particles. The average particle size of the simple silicon can be set, for example, to be smaller than the average particle size of the carbon material and the average particle size of the silicon oxide. In this manner, the simple silicon, which largely changes in the volume by the charge/discharge cycle, has a relatively smaller particle size, and the carbon material and the silicon oxide, which changes a little in the volume, have relatively larger particle sizes. Therefore, generation of dendrite and generation of fine powders of the alloy can be more effectively inhibited. Besides, in a charging/discharging process, lithium intercalates/deintercalates into the particles in the order of the particles having a large size, the particles having a small size and the particles having a large size, and also from this point of view, occurrence of residual stress and residual strain can be suppressed. The average particle size of the simple silicon can be, for example, 20 μm or less and preferably 15 μm or less. Besides, the average particle size of the silicon oxide is preferably equal to or smaller than ½ of the average particle size of the carbon material, and the average particle size of the simple silicon is preferably equal to or smaller than ½ of the average particle size of the silicon oxide. Furthermore, it is more preferable that the average particle size of the silicon oxide is equal to or smaller than ½ of the average particle size of the carbon material and that the average particle size of the simple silicon is equal to or smaller than ½ of the average particle size of the silicon oxide. If the average particle sizes are controlled to fall in these ranges, the effect of relaxing the volume expansion can be more effectively attained, and a secondary battery excellent in balance between the energy density and the cycle life and efficiency can be obtained. More specifically, it is preferred that the average particle size of the silicon oxide is equal to or smaller than ½ of the average particle size of graphite and that the average particle size of the simple silicon is equal to or smaller than ½ of the average particle size of the silicon oxide. Furthermore specifically, the average particle size of the simple silicon can be, for example, 20 μm or less and is preferably 15 μm or less.

In addition, a substance obtained by treating the surface of the Si/SiO/C complex with a silane coupling agent may be used as the negative electrode active material.

The binder for negative electrode is not especially limited, and polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, polyamide-imide or the like can be used. Among these, polyimide, polyamide-imide, polyacrylic acids (including a lithium salt, a sodium salt and a potassium salt neutralized with an alkali), and carboxymethyl celluloses (including a lithium salt, a sodium salt and a potassium salt neutralized with an alkali) are preferably used because strong adhesion can be attained by them. The amount of the binder for negative electrode to be used is preferably 5 to 25 parts by mass based on 100 parts by mass of the negative electrode active material from the viewpoint of a trade-off relationship between “sufficient binding force” and “high energy”.

### [2] Positive Electrode

A positive electrode is in a form in which, for example, a positive electrode active material is bound by a binder for positive electrode so to cover a positive electrode collector. Examples of the positive electrode active material include lithium manganese having a layered structure or lithium manganese having a spinel structure, such as LiMnO₂ or LixMn₂O₄ (0<x<2); LiCoO₂, LiNiO₂ or substances in which a part of a transition metal of these is substituted by another metal; lithium transition metal oxides in which specific transition metals occupy less than a half, such as LiNi_{1/3}Co_{1/3}Mn_{1/3}O₂; and substances containing Li more excessively than in a stoichiometric composition in theses lithium transition metal oxides. In particular, Li_{α}Ni_{β}Co_{γ}Al_{δ}O₂ (1≦α≦1.2, β+γ+δ=1, β≧0.7 and γ≦0.2), or Li_{α}Ni_{β}Co_{γ}Mn_{δ}O₂ (1≦α≦1.2, β+γ+δ=1, β≧0.6 and γ≦0.2) is preferable. One of these positive electrode active materials may be singly used, or two or more of them may be used in combination.

As the binder for positive electrode, any of those mentioned as the binder for negative electrode can be used. In particular, from the viewpoint of general-purpose and low cost, polyvinylidene fluoride is preferably used. The amount of the binder for positive electrode to be used is preferably 2 to 10 parts by mass based on 100 parts by mass of the positive electrode active material from the viewpoint of the trade-off relationship between “sufficient binding force” and “high energy”.

As the positive electrode collector, any of those mentioned as the negative electrode collector can be used.

To a positive electrode active material layer containing the positive electrode active material, a conductive assistant may be added for purpose of lowering impedance. Examples of the conductive assistant include carbonaceous fine particles such as graphite, carbon black and acetylene black.

### [3] Collector

As the material of the negative electrode collector, any of known materials may be arbitrarily used, and for example, a metal material such as copper, nickel or SUS is used. In particular, copper is particularly preferably used from the viewpoint of workability and cost. Besides, the negative electrode collector is preferably precedently subjected to a surface-roughening treatment similarly to the positive electrode collector. Furthermore, similarly to the positive electrode collector, the shape of the collector is arbitrary, and may be a foil shape, a plate shape, a mesh shape or the like. Alternatively, a perforated collector of an expanded metal or a punching metal can be used.

The negative electrode can be prepared, for example, by forming a negative electrode active material layer containing the negative electrode active material and the binder for negative electrode on the negative electrode collector. The negative electrode active material layer can be formed by, for example, a doctor blade method, a die coater method, a CVD method, or a sputtering method. Alternatively, after precedently forming the negative electrode active material layer, a thin film of aluminum, nickel or an alloy of them may be formed thereon by vapor deposition, sputtering or the like to be used as the negative electrode collector.

### [4] Electrolyte Solution

The electrolyte solution of the present embodiment contains a conjugated carbonyl compound represented by the following formula (1):

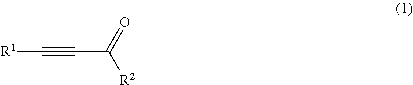

wherein R¹ represents R^{2a} or —CO—R^{2a}, R^{2a} having a meaning given for R², and

R² represents a hydrogen atom, a substituted or unsubstituted acyl group, a substituted or unsubstituted alkyl group, a cycloalkyl group, an alkenyl group, an alkynyl group, a substituted or unsubstituted aromatic group, an oxyalkylene group represented by the following formula (2):

—(R²¹O)ₙ—R²² (2)

wherein R²¹ represents alkylene having 1 to 6 carbon atoms, R²² represents a hydrocarbon group having 1 to 12 carbon atoms, and n represents an integer of 1 to 10,

an unsubstituted alkoxy group, a substituted alkoxy group, a cycloalkyloxy group, an alkenyloxy group, an alkynyloxy group, a substituted or unsubstituted aromatic oxy group, or an oxyalkyleneoxy group represented by the following formula (2b):

—O—(R²¹O)ₙ—R²² (2b)

wherein R²¹ represents alkylene having 1 to 6 carbon atoms, R²² represents a hydrocarbon group having 1 to 12 carbon atoms, and n represents an integer of 1 to 10.

If R¹ represents —CO—R^{2a}, the conjugated carbonyl compound is represented by the following formula (3):

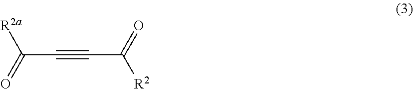

wherein R² and R^{2a} have the same meanings as defined in formula (1).

If each of R² and R^{2a} represents a substituted or unsubstituted acyl group, the acyl group is represented by the following formula:

—CO—R⁷ (5)

wherein R⁷ represents a hydrocarbon group, more specifically, represents an alkyl group having preferably 1 to 12 carbon atoms, more preferably 1 to 6 carbon atoms, or an aryl, alkylaryl or arylalkyl group having 6 to 12 carbon atoms, and these groups may be substituted by CN or mono- or poly-substituted by F.

If each of R² and R^{2a} is an unsubstituted alkyl group, the alkyl group may be linear or branched, and has preferably 1 to 12 carbon atoms, more preferably 1 to 6 carbon atoms, and examples of such a group include methyl, ethyl, propyl, isopropyl, n-butyl, t-butyl and n-hexyl.

If each of R² and R^{2a} is a substituted alkyl group, it has preferably 1 to 18, more preferably 1 to 12, furthermore preferably 1 to 8, and most preferably 1 to 6 carbon atoms. Preferable examples of the substituent include —NR¹¹R¹², halogen and —CN, wherein R¹¹ and R¹² each independently represent H or an alkyl group having 1 to 6 carbon atoms, preferably 1 to 4 carbon atoms. At least one of R¹¹ and R¹² is preferably an alkyl group, and more preferably both of R¹¹ and R¹² are alkyl groups. It should be noted that the number of the carbon atoms of R¹¹ and R¹² are not included in the number of carbon atoms of the alkyl group mentioned above, but it is also preferable that the number of carbon atoms of R¹¹ and R¹² are counted to be included in the aforementioned number of carbon atoms.

Examples of the halogen include fluorine, chlorine, bromine and iodine. In particular, the halogen is preferably fluorine, chlorine or bromine, more preferably fluorine or chlorine, and particularly preferably fluorine. Neither the number of substitution with the halogen nor the substitution position is especially limited, but at least monosubstitution, particularly disubstitution or trisubstitution, at the end of the alkyl group is preferable. The substitution position of —CN is also not especially limited, but substitution at the end of the alkyl group is preferable.

Specific examples of the alkyl group having —NR¹¹R¹² as the substituent, namely, examples of an amino alkyl group, include N,N-diethylaminobutyl, N,N-diethylaminopropyl, N,N-diethylaminoethyl, N,N-diethylaminomethyl, N,N-dimethylaminobutyl, N,N-dimethylaminopropyl, N,N-dimethylaminoethyl, N,N-dimethylaminomethyl, and N-methylaminomethyl.

Examples of the alkyl group having halogen as the substituent, namely, examples of a haloalkyl group, include a fluoroalkyl group (such as —CF₂CF₃, —CF₂CF₂H, —CFHCF₃, —CH₂CF₃, —CHFCF₂H, —CH₂CF₂H, —CH₂CFH₂, —CH₂CH₂CF₃, —CH₂CFHCF₃, —CH₂CF₂CF₃, —CH₂CH₂CH₂CF₃), a chloroalkyl group (such as chlorobutyl, chloropropyl, chloroethyl or chloromethyl), and a bromoalkyl group (such as bromobutyl, bromopropyl, bromoethyl or bromomethyl).

Examples of the alkyl group having —CN as the substituent, namely, examples of a cyanoalkyl group, include cyanoethyl, cyanopropyl, cyanobutyl, cyanopentyl and cyanohexyl.

If each of R² and R^{2a} is a cycloalkyl group, the cycloalkyl group preferably has 3 to 12 carbon atoms, particularly preferably 3 to 6 carbon atoms, and specific examples include cyclopropyl, cyclobutyl, cyclopentyl and cyclohexyl.

If each of R² and R^{2a} is an alkenyl group, the alkenyl group preferably has 2 to 12 carbon atoms, particularly preferably 2 to 6 carbon atoms, and examples include vinyl, 1-propenyl, 2-propenyl and 2-butenyl.

If each of R² and R^{2a} is an alkynyl group, the alkynyl group preferably has 2 to 12 carbon atoms, particularly preferably 2 to 6 carbon atoms, and examples include acetylenyl, 1-propynyl, 2-propynyl and 2-butynyl.

If each of R² and R^{2a} is a substituted or unsubstituted aromatic group, the aromatic group includes an aryl group, an arylalkyl group and an alkylaryl group, and has preferably 6 to 18 carbon atoms, and more preferably 6 to 12 carbon atoms. The aromatic group may be unsubstituted or have a substituent, and preferably has, as a substituent on an aromatic ring, —CN or halogen such as fluorine or chlorine (particularly preferably fluorine).

Specific examples include phenyl, cyanophenyl, fluorophenyl, difluorophenyl, trifluorophenyl, cyanofluorophenyl, cyanodifluorophenyl; benzyl (=a phenyl methyl group), cyanophenyl methyl, fluorophenyl methyl, difluorophenyl methyl, trifluorophenyl methyl, cyanofluorophenyl methyl, cyanodifluorophenyl methyl; 2-phenylethyl, cyano-2-phenylethyl, fluoro-2-phenylethyl, difluoro-2-phenylethyl, trifluoro-2-phenylethyl, cyanofluoro-2-phenylethyl, and cyanodifluoro-2-phenylethyl. The substitution by a cyano group or fluorine may take place at any arbitrary position on the phenyl ring.

If each of R² and R^{2a} is an oxyalkylene group represented by the above formula (2):

—(R²¹O)ₙ—R²² (2)

R²² represents an alkyl group having preferably 1 to 12 carbon atoms, more preferably 1 to 7 carbon atoms, or an aryl group having 6 to 12 carbon atoms, and particularly preferably represents a linear alkyl group having 1 to 7 carbon atoms; and

R²¹ represents alkylene having 1 to 6 carbon atoms, preferably 2 to 4 carbon atoms, and more preferably represents ethylene or propylene, and particularly preferably ethylene; and

n is an integer of 1 to 10, and preferably 1 to 4.

Examples of the moiety of —(R²¹O)ₙ—, namely, a moiety (poly)oxyalkylene, include oxyethylene (=an ethylene oxide group), dioxyethylene (=a diethylene oxide group), trioxyethylene (=a triethylene oxide group), tetraoxyethylene (=a tetraethylene oxide group), oxypropylene (=a propylene oxide group), dioxypropylene (=a dipropylene oxide group), trioxypropylene (=a tripropylene oxide group), and tetraoxypropylene (=a tetrapropylene oxide group). The alkylene structure of R²¹ may be bonded at an arbitrary position as in propane-1,2-diyl, propane-1,3-diyl or the like.

If each of R² and R^{2a} is an unsubstituted alkoxy group, the alkoxy group may be linear or branched, and has preferably 1 to 12 carbon atoms, more preferably 1 to 6 carbon atoms, and examples include methoxy, ethoxy, a propoxy group, an isopropoxy group, a n-butoxy group, t-butoxy and a n-hexoxy group. In particular, if R¹ represents —CO—R^{2a} in formula (1), a compound of formula (1) in which R² and R^{2a} are the same and represent an unsubstituted alkoxy group having 3 to 12 carbon atoms, preferably 3 to 6 carbon atoms may be preferably used in one embodiment of the present invention. Alternatively, an alkoxy group having 7 to 12 carbon atoms is also preferably used.

If each of R² and R^{2a} is a substituted alkoxy group, the substituted alkoxy group is preferably represented by —O—R^{2b} in which R^{2b} represents the above “substituted alkyl group”. Namely, the substituted alkoxy group has preferably 1 to 18, more preferably 1 to 12, furthermore preferably 1 to 8, and most preferably 1 to 6 carbon atoms, and the substituent is preferably —NR¹¹R¹², halogen or —CN. Here, R¹¹ and R¹² each independently represent H or an alkyl group having 1 to 6 carbon atoms, preferably 1 to 4 carbon atoms. Preferably, at least one of R¹¹ and R¹² is an alkyl group, and more preferably, both of them are alkyl groups. It should be noted that the number of carbon atoms of R¹¹ and R¹² are not included in the number of carbon atoms of the alkyl group mentioned above, but it is also preferable that the number of carbon atoms of R¹¹ and R¹² are counted to be included in the aforementioned number of carbon atoms.

Examples of the halogen include fluorine, chlorine, bromine and iodine. In particular, the halogen is preferably fluorine, chlorine or bromine, more preferably fluorine or chlorine, and particularly preferably fluorine. Neither the number of substitution with the halogen nor the substitution position is especially limited, but at least monosubstitution, particularly disubstitution or trisubstitution, at the end of the alkyl group, is preferable. The substitution position of —CN is also not especially limited, but substitution at the end of the alkyl group is preferable.

Specific examples of the alkoxy group having —NR¹¹R¹² as the substituent, namely, examples of an amino alkoxy group, can include N,N-diethylaminobutoxy, N,N-diethylaminopropoxy, N,N-diethylaminoethoxy, N,N-diethylaminomethoxy, N,N-dimethylaminobutoxy, N,N-dimethylaminopropoxy, N,N-dimethylaminoethoxy, N,N-dimethylaminomethoxy, and N-methylaminomethoxy.

Examples of the alkoxy group having halogen as the substituent, namely, examples of a haloalkoxy group, can include a fluoroalkoxy group (such as —OCF₂CF₃, —OCF₂CF₂H, —OCFHCF₃, —OCH₂CF₃, —OCHFCF₂H, —OCH₂CF₂H, —OCH₂CFH₂, —OCH₂CH₂CF₃, —OCH₂CFHCF₃, —OCH₂CF₂CF₃, —OCH₂CH₂CH₂CF₃), a chloroalkoxy group (such as chlorobutoxy, chloropropoxy, chloroethoxy or chloromethoxy), and a bromoalkoxy group (such as bromobutoxy, bromopropoxy, bromoethoxy or bromomethoxy).

Examples of the alkoxy group having —CN as the substituent, namely, examples of a cyanoalkoxy group, include cyanoethoxy, cyanopropoxy, cyanobutoxy, cyanopentoxy and cyanohexoxy.

If each of R² and R^{2a} is a cycloalkyloxy group, the cycloalkyloxy group preferably has 3 to 12 carbon atoms, particularly preferably 3 to 6 carbon atoms, and specific examples include cyclopropyloxy, cyclobutyloxy, cyclopentyloxy and cyclohexyloxy.

If each of R² and R^{2a} is an alkenyloxy group, the alkenyloxy group preferably has 2 to 12 carbon atoms, particularly preferably 2 to 6 carbon atoms, and examples include vinyloxy, 1-propenyloxy, 2-propenyloxy and 2-butenyloxy.

If each of R² and R^{2a} is an alkynyloxy group, the alkynyloxy group preferably has 2 to 12 carbon atoms, particularly preferably 2 to 6 carbon atoms, and examples include acetylenyloxy, 1-propynyloxy, 2-propynyloxy and 2-butynyloxy.

If each of R² and R^{2a} is a substituted or unsubstituted aromatic oxy group, this group includes an aryloxy group, an arylalkoxy group and an alkylaryloxy group, and has preferably 6 to 18 carbon atoms, and more preferably 6 to 12 carbon atoms. The aromatic oxy group may be unsubstituted or may have a substituent, and preferably has, as the substituent on an aromatic ring, —CN or halogen such as fluorine or chlorine (particularly preferably fluorine).

Specific examples include phenoxy, cyanophenoxy, fluorophenoxy, difluorophenoxy, trifluorophenoxy, cyanofluorophenoxy, cyanodifluorophenoxy; benzyloxy (=a phenyl methoxy group), cyanophenyl methoxy, fluorophenyl methoxy, difluorophenyl methoxy, trifluorophenyl methoxy, cyanofluorophenyl methoxy, cyanodifluorophenyl methoxy; 2-phenylethoxy, cyano-2-phenylethoxy, fluoro-2-phenylethoxy, difluoro-2-phenylethoxy, trifluoro-2-phenylethoxy, cyanofluoro-2-phenylethoxy, and cyanodifluoro-2-phenylethoxy. The substitution by a cyano group or fluorine may take place at any arbitrary position on the phenyl ring.

If each of R² and R^{2a} is an oxyalkyleneoxy group represented by the above formula (2b);

—O—(R²¹O)ₙ—R²² (2b)

R²² represents an alkyl group having preferably 1 to 12 carbon atoms, more preferably 1 to 7 carbon atoms, or an aryl group having 6 to 12 carbon atoms, and particularly preferably represents a linear alkyl group having 1 to 7 carbon atoms; and

R²¹ represents alkylene having 1 to 6 carbon atoms, preferably 2 to 4 carbon atoms, more preferably represents ethylene or propylene, and particularly preferably represents ethylene; and

n is an integer of 1 to 10, and preferably 1 to 4.

Examples of the moiety of —(R²¹O)ₙ—, namely, a moiety of (poly)oxyalkylene, include oxyethylene (=an ethylene oxide group), dioxyethylene (=a diethylene oxide group), trioxyethylene (=a triethylene oxide group), tetraoxyethylene (=a tetraethylene oxide group), oxypropylene (=a propylene oxide group), dioxypropylene (=a dipropylene oxide group), trioxypropylene (=a tripropylene oxide group), and tetraoxypropylene (=a tetrapropylene oxide group). The alkylene structure of R²¹ may be bonded at an arbitrary position as in propane-1,2-diyl, propane-1,3-diyl or the like.

Among the aforementioned compounds, the conjugated carbonyl compound represented by formula (1) is preferably a compound represented by the above formula (3), and particularly preferably a compound in which R² and R^{2a} represent an unsubstituted alkoxy group having 1 to 12 carbon atoms; a substituted alkoxy group selected from the group consisting of a fluoroalkoxy group, an amino alkoxy group having a substituent —NR¹¹R¹² (wherein R¹¹ and R¹² each independently represent H or an alkyl group having 1 to 6 carbon atoms), and a cyanoalkoxy group;

a substituted or unsubstituted aromatic oxy group selected from the group consisting of an aryloxy group, an aryl alkyloxy group and an alkyl aryloxy group, which optionally have —CN or halogen as a substituent on an aromatic ring; or

an oxyalkyleneoxy group represented by the following formula (2):

—O—(R²¹O)ₙ—R²² (2)

wherein R²¹ represents alkylene having 1 to 6 carbon atoms, R²² represents a hydrocarbon group having 1 to 12 carbon atoms, and n represents an integer of 1 to 10.

Accordingly, this preferable compound is represented by the following formula (4):

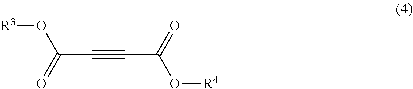

wherein, as for R³ and R⁴, R³O— and R⁴O— each represent the unsubstituted alkoxy group, the substituted alkoxy group, the substituted or unsubstituted aromatic oxy group or the oxyalkyleneoxy group mentioned above as the preferable R^{2a} and R². More preferable examples of these groups are those mentioned above.

Examples of the conjugated carbonyl compound used in the present invention include the following compounds:

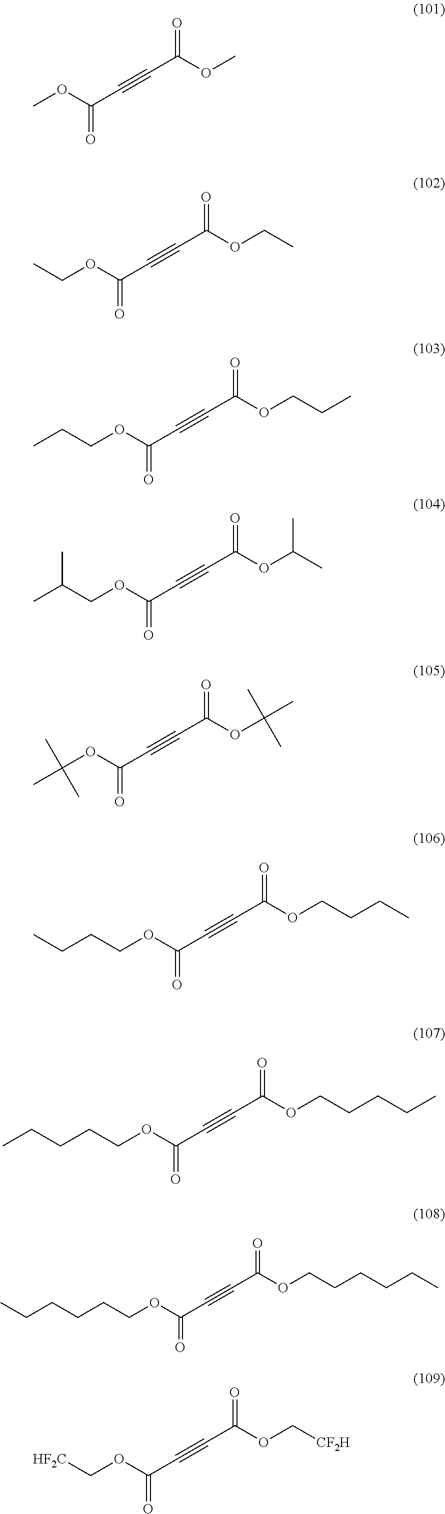

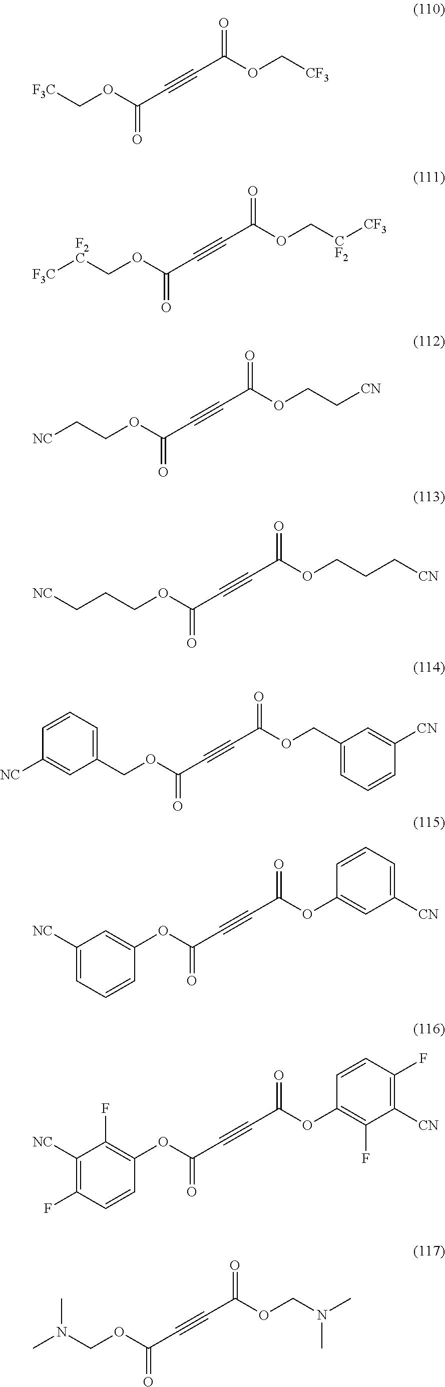

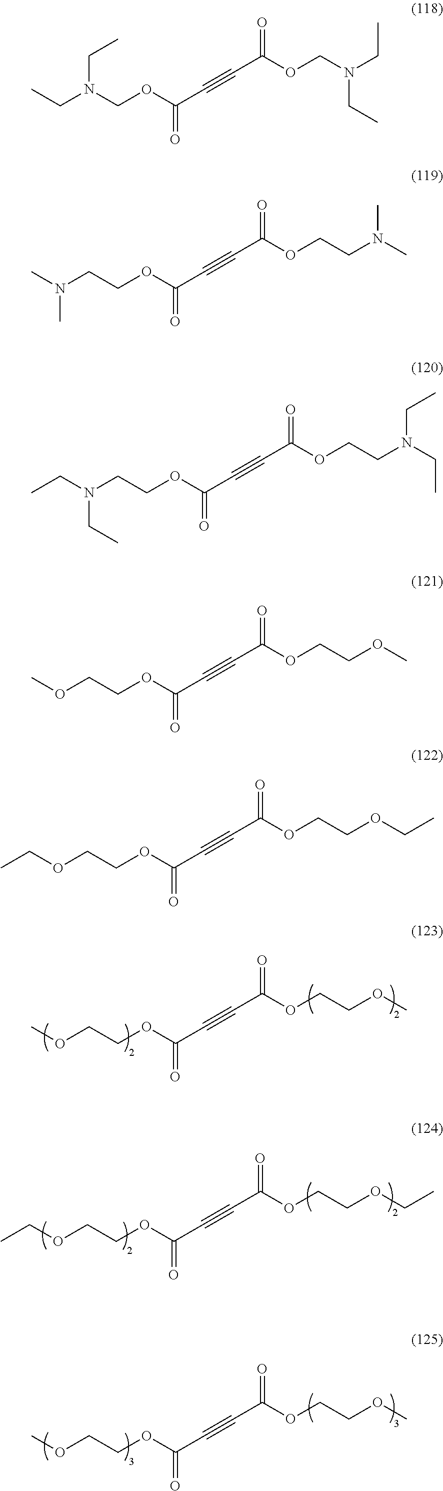

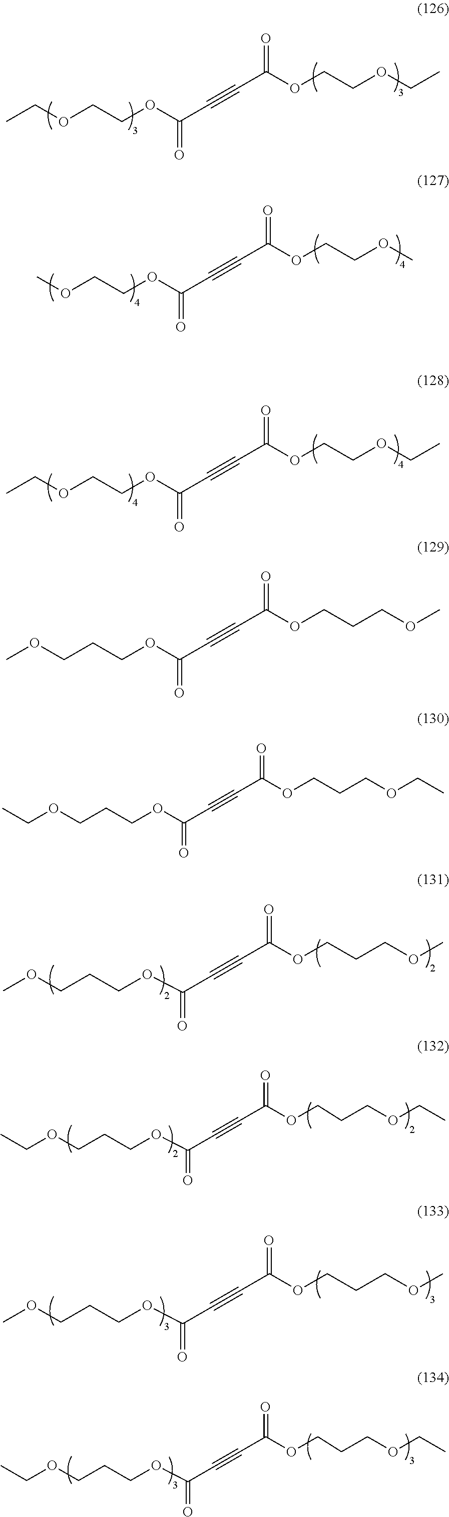

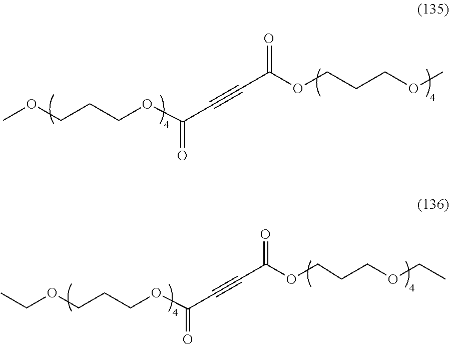

The conjugated carbonyl compound used in the present invention can be synthesized with reference to, for example, the following Reference Literatures 1 to 3:
Reference Literature 1: Encyclopedia of Experimental Chemistry 22, 4th edition, Organic synthesis IV Acid, Amino Acid, Peptide 1, 2 Esters, p. 44, edited by The Chemical Society of Japan, published by Maruzen Co., Ltd.;
Reference Literature 2; E. H. Huntress, T. E. Lesslie, J. Bornstein, Organic Synthesis, 1963, vol. 4, p. 329; and
Reference Literature 3; B. Neises, W. Steglich, Organic Synthesis, 1985, vol. 63, p. 183

Examples of a synthetic route to the conjugated carbonyl compound are shown as synthetic schemes represented by the following formulas (31a) and (31b):

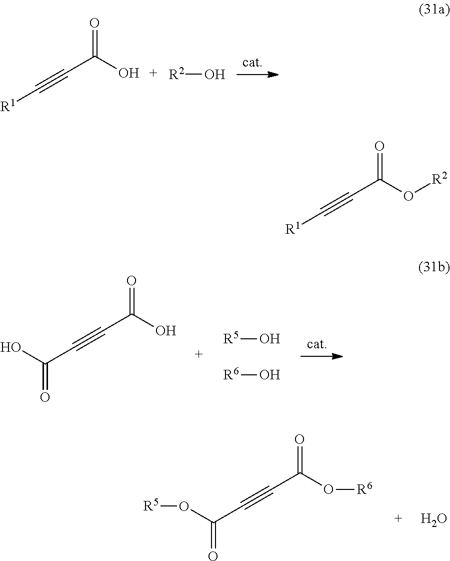

wherein R¹ and R² have the same meanings as defined above in formula (1), and as for R⁵ and R⁶, R⁵O— and R⁶O— each represent the unsubstituted alkoxy group, the substituted alkoxy group, the substituted or unsubstituted aromatic oxy group or the oxyalkyleneoxy group mentioned above for R^{2a} and R².

Specifically, the compound can be synthesized by a method in which acetylene dicarboxylic acid is reacted with R⁵OH and R⁶OH in the presence of a catalytic amount of an acid. Here, R⁵ and R⁶ have the same meanings as defined in formula (1). The acid to be used may be a proton acid or a Lewis acid. As the acid, any of mineral acids (such as sulfuric acid and hydrochloric acid), organic acids (such as aromatic sulfonic acid), and Lewis acids (such as boron fluoride etherate: BF₃Et₂O) can be used.

Alternatively, as represented by the following formulas (32a) and (32b), the compound can be also synthesized by a method in which an acetylene dicarboxylic acid halide is synthesized by using a halogenating agent such as thionyl chloride or oxalyl chloride, and the acetylene dicarboxylic acid halide is reacted with alcohol.

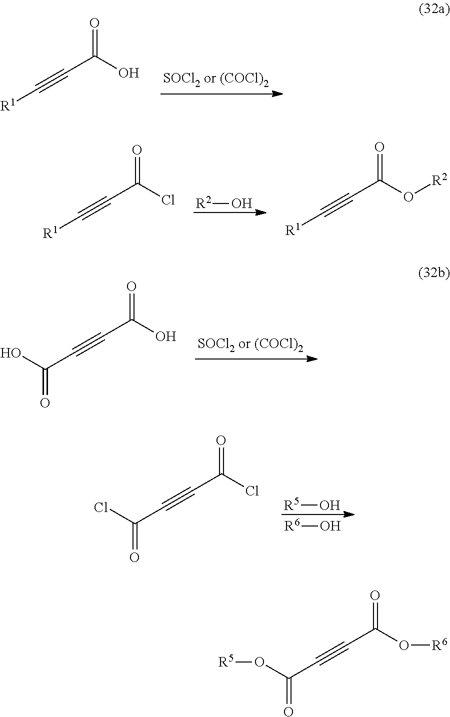

Further alternatively, the compound can be synthesized also by a method in which a condensation agent represented by the following formula (33) is used for activating carboxylic acid in reacting acetylene dicarboxylic acid with alcohol, R⁵OH and R⁶OH. Here, the rate of reaction may be increased in some cases by adding a reaction accelerator such as N,N-dimethylaminopyridine.

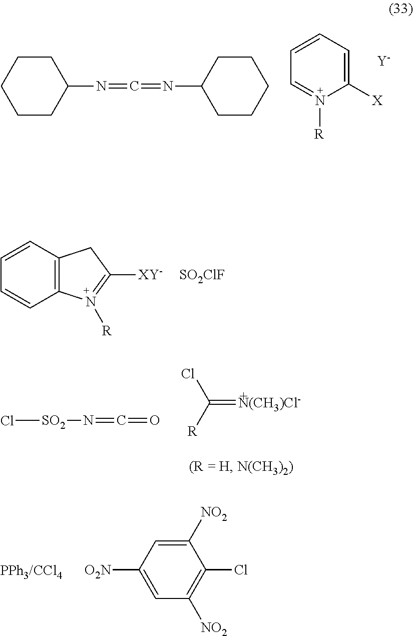

Incidentally, if an ester compound in which R⁵ and R⁶ are the same is to be synthesized in the above reaction, merely one of R⁵OH and R⁶OH may be used. If an ester compound in which R⁵ and R⁶ are different from each other (i.e., an asymmetric ester compound) is to be synthesized, both of R⁵OH and R⁶OH are used. Here, a reaction product containing the asymmetric ester compound in a large content may be obtained in some cases by, for example, successively reacting R⁵OH and R⁶OH.

In the present invention, the content of the conjugated carbonyl compound of the above formula (1) in the electrolyte solution is, for example, 0.01 to 10% by mass, and preferably 0.1% by mass or more and preferably 4% by mass or less.

The electrolyte solution used in the present embodiment includes a nonaqueous electrolyte solution that is stable in the operating potential of a battery. Specific examples of the nonaqueous electrolyte solution include aprotic organic solvents like cyclic carbonates such as propylene carbonate (PC), ethylene carbonate (EC), fluoroethylene carbonate (FEC), t-difluoroethylene carbonate (t-DFEC), butylene carbonate (BC), vinylene carbonate (VC) and vinyl ethylene carbonate (VEC); chain carbonates such as allyl methyl carbonate (AMC), dimethyl carbonate (DMC), diethyl carbonate (DEC), ethyl methyl carbonate (EMC) and dipropyl carbonate (DPC); propylene carbonate derivatives; aliphatic carboxylates such as methyl formate, methyl acetate and ethyl propionate; and cyclic esters such as γ-butyrolactone (GBL). The nonaqueous electrolyte solutions may be used singly or in combination of two or more of them. Alternatively, a sulfur-containing cyclic compound such as sulfolane, fluorinated sulfolane, propane sultone or propene sultone can be used.

The electrolyte solution preferably further contains a fluorinated ether compound. A fluorinated ether compound has high affinity with Si, and hence, the cycle characteristic (particularly, the capacity retention) of the secondary battery can be improved by adding it to the electrolyte solution. The fluorinated ether compound may be a fluorinated chain ether compound having a structure in which a part of hydrogen of a non-fluorinated chain ether compound is substituted by fluorine, or a fluorinated cyclic ether compound having a structure in which a part of hydrogen of a non-fluorinated cyclic ether compound is substituted by fluorine.

Examples of the non-fluorinated chain ether compound include non-fluorinated chain monoether compounds such as dimethyl ether, methyl ethyl ether, diethyl ether, methyl propyl ether, ethyl propyl ether, dipropyl ether, methyl butyl ether, ethyl butyl ether, propyl butyl ether, dibutyl ether, methyl pentyl ether, ethyl pentyl ether, propyl pentyl ether, butyl pentyl ether and dipentyl ether; and non-fluorinated chain diether compounds such as 1,2-dimethoxyethane (DME), 1,2-diethoxyethane (DEE), ethoxymethoxyethane (EME), 1,2-dipropoxyethane, propoxyethoxyethane, propoxymethoxyethane, 1,2-dibutoxyethane, butoxypropoxyethane, butoxyethoxyethane, butoxymethoxyethane, 1,2-dipentoxyethane, pentoxybutoxyethane, pentoxypropoxyethane, pentoxyethoxyethane and pentoxymethoxyethane.

Examples of the non-fluorinated cyclic ether compound include non-fluorinated cyclic monoether compounds such as ethylene oxide, propylene oxide, oxetane, tetrahydrofuran, 2-methyl tetrahydrofuran, 3-methyl tetrahydrofuran, tetrahydropyran, 2-methyl tetrahydropyran, 3-methyl tetrahydropyran and 4-methyl tetrahydropyran; and non-fluorinated cyclic diether compounds such as 1,3-dioxolane, 2-methyl-1,3-dioxolane, 4-methyl-1,3-dioxolane, 1,4-dioxane, 2-methyl-1,4-dioxane, 1,3-dioxane, 2-methyl-1,3-dioxane, 4-methyl-1,3-dioxane, 5-methyl-1,3-dioxane, 2,4-dimethyl-1,3-dioxane and 4-ethyl-1,3-dioxane.

The fluorinated chain ether compound is preferably represented by the following formula (10):

Rₐ—O—R_{b} (10)

In formula (10), Rₐ and R_{b} each independently represent an alkyl group or a fluorine-substituted alkyl group, and at least one of Rₐ and R_{b} is a fluorine-substituted alkyl group.

In each of Rₐ and R_{b}, the number of carbon atoms of the alkyl group is preferably 1 to 12, more preferably 1 to 8, furthermore preferably 1 to 6, and particularly preferably 1 to 4. Besides, in formula (10), the alkyl group includes a linear, branched or cyclic group, and is preferably a linear group.

At least one of Rₐ and R_{b} is a fluorine-substituted alkyl group. A fluorine-substituted alkyl group refers to a substituted alkyl group having a structure in which at least one hydrogen atom of an unsubstituted alkyl group is substituted by a fluorine atom. The fluorine-substituted alkyl group is preferably linear. Furthermore, Rₐ and R_{b} each independently represent preferably a fluorine-substituted alkyl group having 1 to 6 carbon atoms, and more preferably a fluorine-substituted alkyl group having 1 to 4 carbon atoms.

From the viewpoint of safety, the fluorinated chain ether compound is more preferably represented by the following formula (11):

H—(CX¹X²—CX³X⁴)ₙ—CH₂O—CX⁵X⁶—CX⁷X⁸—H (11)

In formula (11), n represents 1, 2, 3 or 4, and X¹ to X⁸ each independently represent a fluorine atom or a hydrogen atom. However, at least one of X¹ to X⁴ is a fluorine atom, and at least one of X⁵ to X⁸ is a fluorine atom.

In formula (11), each occurrence of X¹ to X⁴ in n times may be independent of one another.

In formula (11), the atomic ratio of fluorine atoms to hydrogen atoms is preferably 1 or more. That is, a relationship of (total number of fluorine atoms)/(total number of hydrogen atoms) 1 is preferably satisfied.

From the viewpoint of safety, the fluorinated chain ether compound is furthermore preferably represented by the following formula (4):

H—(CF₂—CF₂)ₙ—CH₂O—CF₂—CF₂—H (12)

In formula (12), n represents 1 or 2.

Examples of the chain fluorinated ether compound include CF₃OCH₃, CF₃OC₂H₆, F(CF₂)₂OCH₃, F(CF₂)₂OC₂H₅, F(CF₂)₃OCH₃, F(CF₂)₃OC₂H₅, F(CF₂)₄OCH₃, F(CF₂)₄OC₂H₅, F(CF₂)₅OCH₃, F(CF₂)₅OC₂H₅, F(CF₂)₈OCH₃, F(CF₂)₈OC₂H₅, F(CF₂)₉OCH₃, CF₃CH₂OCH₃, CF₃CH₂OCHF₂, CF₃CF₂CH₂OCH₃, CF₃CF₂CH₂OCHF₂, CF₃CF₂CH₂O(CF₂)₂H, CF₃CF₂CH₂O(CF₂)₂F, HCF₂CH₂OCH₃, H(CF₂)₂OCH₂CH₃, H(CF₂)₂OCH₂CF₃, H(CF₂)₂CH₂OCHF₂, H(CF₂)₂CH₂O(CF₂)₂H, H(CF₂)₂CH₂O(CF₂)₃H, H(CF₂)₃CH₂O(CF₂)₂H, (CF₃)₂CHOCH₃, (CF₃)₂CHCF₂OCH₃, CF₃CHFCF₂OCH₃, CF₃CHFCF₂OCH₂CH₃, CF₃CHFCF₂CH₂OCHF₂.

The content of the fluorinated chain ether compound in the electrolyte solution is, for example, 1 to 70% by mass. The content of the fluorinated chain ether compound in the electrolyte solution is preferably 2 to 60% by mass, more preferably 3 to 55% by mass, and furthermore preferably 4 to 50% by mass. If the content of the fluorinated chain ether compound is 50% by mass or less, a Li ion is easily dissociated from a supporting electrolyte, and hence, the conductivity of the electrolyte solution is improved. On the other hand, if the content of the fluorinated chain ether compound is 1% by mass or more, it is believed that the reductive decomposition of the electrolyte solution on the negative electrode can be easily inhibited.

Specific examples of the supporting electrolyte contained in the electrolyte solution include, but are not especially limited to, lithium salts such as LiPF₆, LiAsF₆, LiAlCl₄, LiClO₄, LiBF₄, LiSbF₆, LiCF₃SO₃, LiC₄F₉SO₃, Li(CF₃SO₂)₂, LiN(CF₃SO₂)₂. These supporting electrolytes may be used singly or in combination of two or more of them.

### [5] Separator

A separator is not especially limited, and a porous film or a nonwoven fabric of polypropylene, polyethylene or the like can be used. Alternatively, a separator obtained by laminating such a material may be used.

### [6] Outer Package

An outer package is not especially limited, and for example, a laminated film can be used. Any laminated film can be appropriately selected as long as it is stable against the electrolyte solution and has a sufficient steam barrier property. As the laminated film used as the outer package, for example, a laminated film of aluminum, silica, polypropylene coated with alumina, or polyethylene can be used. In particular, from the viewpoint of inhibiting the volume expansion, an aluminum laminated film is preferably used.

In the secondary battery using a laminated film as the outer package, the strain of the electrode element caused when a gas is generated is extremely large as compared with that caused in a secondary battery using a metal can as the outer package. This is because the laminated film is more easily deformed by the internal pressure of the secondary battery than the metal can. Furthermore, when sealing a secondary battery using a laminated film as the outer package, the pressure within the battery is generally decreased to be lower than the atmospheric pressure, and hence, there remains no spare room within the battery. Therefore, the generation of a gas immediately leads to the volume change of the battery or the deformation of the electrode element in some cases.

In a secondary battery of the present embodiment, these problems can be overcome. As a result, there can be provided a laminated type lithium ion secondary battery that is inexpensive and shows an excellent degree of freedom in design of cell capacity by changing the number of laminated layers.

A typical example of the layered structure of the laminated film is a structure in which a metal thin film layer and a fusion-bondable resin layer are laminated. Another typical example of the layered structure of the laminated film is a structure in which a protective layer of a film of polyester such as polyethylene terephthalate or nylon is further laminated on a surface of the metal thin film layer opposite to the fusion-bondable resin layer. When sealing a battery element, the battery element is surrounded with the fusion-bondable resin layer opposed. As the metal thin film layer, for example, a foil of Al, Ti, Ti alloy, Fe, stainless steel, Mg alloy or the like having a thickness of 10 to 100 μm is used. A resin used in the fusion-bondable resin layer is not especially limited as long as it is fusible with heat. As the fusion-bondable resin layer, the usable materials includes, for example, polypropylene, polyethylene, an acid-modified product of these resins, polyphenylene sulfide, polyester such as polyethylene terephthalate, polyamide, an ethylene-vinyl acetate copolymer, or an ionomer resin obtained by intermolecular-bonding an ethylene-methacrylic acid copolymer or an ethylene-acrylic acid copolymer with metal ions. The thickness of the fusion-bondable resin layer is preferably 10 to 200 μm, and more preferably 30 to 100 μm.

### [7] Battery Structure

The structure of the secondary battery is not especially limited, and for example, a laminated type structure in which an electrode element including a positive electrode and a negative electrode opposing each other, and an electrolyte solution are housed in an outer package can be employed.

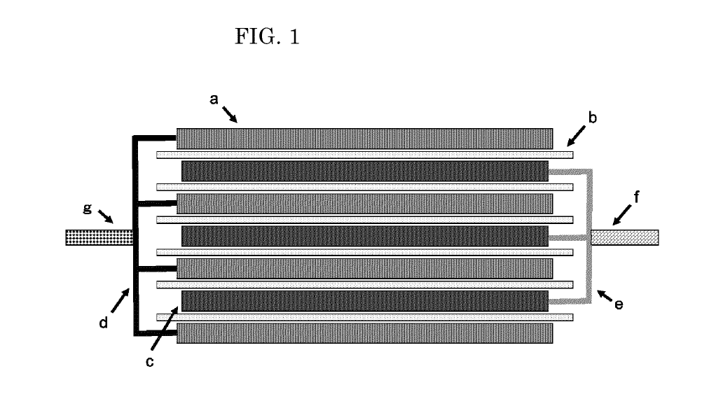

FIG. 1 is a schematic cross-sectional view illustrating the structure of an electrode element of a laminated type secondary battery. In this electrode element, a plurality of positive electrodes c and a plurality of negative electrode a both having a planar structure are alternately stacked with a separator b sandwiched therebetween. Positive electrode collectors e of the respective positive electrodes c are welded to one another in end portions not covered with a positive electrode active material so as to be electrically connected to one another, and a positive electrode terminal f is further welded to the welded portion among them. Negative electrode collectors d of the respective negative electrodes a are welded to one another in end portions not covered with a negative electrode active material so as to be electrically connected to one another, and a negative electrode terminal g is further welded to the welded portion among them.

In the electrode element having such a planar layered structure, no portion has small R (like a portion close to a core of a winding structure), and therefore, such an electrode element has an advantage that it is difficult to be harmfully affected by the volume change of the electrode caused through the charge/discharge cycle as compared with an electrode element having a winding structure. In other words, it is effectively used as an electrode element using an active material with which the volume expansion is liable to occur. On the other hand, since an electrode is bent in an electrode element having a winding structure, the structure is easily warped if the volume change is caused. In particular, if a negative electrode active material largely changed in the volume through the charge/discharge cycle, such as a silicon oxide, is used, the capacity is largely lowered through the charge/discharge cycle in a secondary battery using an electrode element having a winding structure.

In the electrode element having a planar layered structure, however, if a gas is generated between the electrodes, there arises a problem that the generated gas is liable to stay between the electrodes. This is for the following reason: In the electrode element having a winding structure, tension is applied to the electrodes and hence a distance between the electrodes is difficult to increase, but in the electrode element having a layered structure, a distance between the electrodes is easily increased. If an aluminum laminated film is used as the outer package, this problem becomes particularly conspicuous.

In the present invention, since the conjugated carbonyl compound represented by the above formula (1) is contained in the electrolyte solution, the aforementioned problem can be solved, and hence, even a laminated type lithium ion secondary battery using a high-energy negative electrode can make long-life driving.

Accordingly, the secondary battery according to one embodiment of the present invention is a laminated type secondary battery containing an electrode element including a positive electrode and a negative electrode opposing each other, an electrolyte solution, and an outer package housing the electrode element and the electrolyte solution. The negative electrode contains a negative electrode active material including at least one of a metal (a) alloyable with lithium and a metal oxide (b) capable of intercalating/deintercalating lithium ions, and is bound to a negative electrode collector with a binder for negative electrode, and the electrolyte solution contains a conjugated carbonyl compound represented by the above formula. It is noted that the conjugated carbonyl compound represented by the above formula (1) is effectively used in a secondary battery using an electrode element having a winding structure.

### EXAMPLES

Now, the present invention will be specifically described with reference to examples, and it is noted that the present invention is not limited to these examples.

### Example 1

Simple silicon having an average particle size of 5 μm used as silicon and graphite having an average particle size of 30 μm used as a carbon material were weighed in a mass ratio of 90:10 and were mixed by so-called mechanical milling for 24 hours to give a negative electrode active material. This negative electrode active material (average particle size D₅₀=5 μm) and polyimide (PI, manufactured by Ube Industries, Ltd., trade name: U-varnish A) used as a binder for negative electrode were weighed in a mass ratio of 85:15, and were mixed with n-methylpyrrolidone to obtain a negative electrode slurry. The negative electrode slurry was applied to a copper foil in a thickness of 10 μm and then dried, and the resultant was subjected to a heat treatment under a nitrogen atmosphere at 300° C. to prepare a negative electrode.

Lithium nickelate (LiNi_{0.75}Cu_{0.15}Al_{0.15}O₂) used as a positive electrode active material, carbon black used as a conductive assistant, and polyvinylidene fluoride used as a binder for positive electrode were weighed in a mass ratio of 90:5:5, and were mixed with n-methylpyrrolidone to obtain a positive electrode slurry. The positive electrode slurry was applied to an aluminum foil in a thickness of 20 μm and then dried, and the resultant was pressed to prepare a positive electrode.

Three layers of the positive electrode and four layers of the negative electrode obtained as described above were alternately stacked with a polypropylene porous film used as a separator sandwiched therebetween. End portions of positive electrode collectors not covered with the positive electrode active material and end portions of negative electrode collectors not covered with the negative electrode active material were respectively welded to one another, and a positive electrode terminal of aluminum and a negative electrode terminal of nickel were respectively welded onto the welded portions, and thus, an electrode element having a planar layered structure was obtained.

On the other hand, a compound containing a conjugated carbonyl compound represented by the above formula (101) was mixed, to a concentration of 2% by mass, with a liquid containing LiPF₆ as a supporting electrolyte dissolved in a concentration of 1 mol/L in a carbonate nonaqueous electrolyte solvent containing EC/DEC=30/70 (in a volume ratio), thereby preparing an electrolyte solution.

The aforementioned electrode element was wrapped with an aluminum laminated film used as an outer package, and the electrolyte solution was injected into the inside of the outer package. The resultant was then sealed while reducing the pressure to 0.1 atm, thereby producing a secondary battery.

### Examples 2 to 13

Secondary batteries were produced in the same manner as in Example 1 except that compounds represented by the above formulas (102), (104), (105), (106), (109), (110), (111), (115), (116), (118), (120), (122) were respectively used as the conjugated carbonyl compound.

### Example 14

A secondary battery was produced in the same manner as in Example 1 except that the polyimide used as the negative electrode binder was replaced with polyamide-imide (PAL manufactured by Toyobo Co., Ltd., trade name: VYLOMAX (registered trademark)).

### Examples 15 to 26

Secondary batteries were produced in the same manner as in Example 14 except that compounds represented by the above formulas (102), (104), (105), (106), (109), (110), (111), (115), (116), (118), (120), (122) were respectively used as the conjugated carbonyl compound.

### Example 27

Simple silicon having an average particle size of 5 μm used as silicon, amorphous silicon oxide (SiOₓ, 0<x≦2) having an average particle size of 13 μm used as a silicon compound, and graphite having an average particle size of 30 μm used as a carbon material were weighed in a mass ratio of 29:61:10, and were mixed by so-called mechanical milling for 24 hours to give a negative electrode active material containing a Si/SiO/C complex. In this negative electrode active material, the simple silicon was dispersed in the silicon oxide (SiOₓ, 0<x≦2).

Then, a secondary battery was produced in the same manner as in Example 1 except that this negative electrode active material (average particle size D₅₀=5 μm) containing the Si/SiO/C complex was used.

### Examples 28 to 39

Secondary batteries were produced in the same manner as in Example 27 except that compounds represented by the above formulas (102), (104), (105), (106), (109), (110), (111), (115), (116), (118), (120), (122) were respectively used as the conjugated carbonyl compound.

### Example 40

A secondary battery was produced in the same manner as in Example 27 except that the polyimide used as the negative electrode binder was replaced with polyamide-imide (PAT, manufactured by Toyobo Co., Ltd., trade name: VYLOMAX (registered trademark)).

### Examples 41 to 52

Secondary batteries were produced in the same manner as in Example 40 except that compounds represented by the above formulas (102), (104), (105), (106), (109), (110), (111), (115), (116), (118), (120), (122) were respectively used as the conjugated carbonyl compound.

### Comparative Example 1

A secondary battery was produced in the same manner as in Example 1 except that the electrolyte solution used was a liquid containing LiPF₆ as a supporting electrolyte dissolved in a concentration of 1 mol/L in a carbonate nonaqueous electrolyte solvent containing EC/DEC=30/70 (in a volume ratio).

### Comparative Example 2

A secondary battery was produced in the same manner as in Example 16 except that the electrolyte solution used was a liquid containing LiPF₆ as a supporting electrolyte dissolved in a concentration of 1 mol/L in a carbonate nonaqueous electrolyte solvent containing EC/DEC=30/70 (in a volume ratio).

### Comparative Example 3

A secondary battery was produced in the same manner as in Example 31 except that the electrolyte solution used was a liquid containing LiPF₆ as a supporting electrolyte dissolved in a concentration of 1 mol/L in a carbonate nonaqueous electrolyte solvent containing EC/DEC=30/70 (in a volume ratio) was used as the electrolyte solution.

### Comparative Example 4

A secondary battery was produced in the same manner as in Example 45 except that the electrolyte solution used was a liquid containing LiPF₆ as a supporting electrolyte dissolved in a concentration of 1 mol/L in a carbonate nonaqueous electrolyte solvent containing EC/DEC=30/70 (in a volume ratio) was used as the electrolyte solution.

<Evaluation>

In the secondary batteries produced in Examples 1 to 52 and Comparative Examples 1 to 4, cycle characteristics shown under a high-temperature environment were evaluated.

Specifically, each secondary battery was subjected to a test in which a charge/discharge cycle was repeated 50 times in a voltage range of 2.5 V to 4.1 V in a thermostat chamber kept at 60° C. Then, a retention ratio was calculated as (the discharge capacity at 50th cycle)/(the discharge capacity at 5th cycle) (unit: %). Also, an expansion ratio was calculated as (the battery volume at 50th cycle)/(the battery volume before repeating cycle) (unit: %). The results are shown in Tables 1 to 3.

Incidentally, the retention ratio was determined as “∘∘” when it is 75% or more, determined as “∘” when it is 50% or more and less than 75%, determined as “Δ” when it is 25% or more and less than 50%, and determined as “x” when it is less than 25%. The expansion ratio was determined as “∘∘” when it is less than 4%, determined as “∘” when it is 4% or more and less than 10%, determined as “Δ” when it is 10% or more and less than 20%, and determined as “x” when it is 20% or more.

TABLE 1

| | Negative | | | Cycle characteristic | | | |
|---|---|---|---|---|---|---|---|
| | electrode | | | at 60° C. | | | |
| | active | Binder | Conju- | Retention | | Expansion | |
| | material | for | gated | ratio | | ratio | |
| | Si/SiOₓ/C | negative | carbonyl | | Judg- | | Judg- |
| Example | (mass ratio) | electrode | compound | % | ment | % | ment |
| Ex. 1 | 90/0/10 | PI | 101 | 53 | ∘ | 5 | ∘ |
| Ex. 2 | 90/0/10 | PI | 102 | 54 | ∘ | 6 | ∘ |
| Ex. 3 | 90/0/10 | PI | 104 | 57 | ∘ | 7 | ∘ |
| Ex. 4 | 90/0/10 | PI | 105 | 55 | ∘ | 6 | ∘ |
| Ex. 5 | 90/0/10 | PI | 106 | 57 | ∘ | 7 | ∘ |
| Ex. 6 | 90/0/10 | PI | 109 | 58 | ∘ | 7 | ∘ |
| Ex. 7 | 90/0/10 | PI | 110 | 67 | ∘ | 5 | ∘ |
| Ex. 8 | 90/0/10 | PI | 111 | 63 | ∘ | 6 | ∘ |
| Ex. 9 | 90/0/10 | PI | 115 | 67 | ∘ | 5 | ∘ |
| Ex. 10 | 90/0/10 | PI | 116 | 67 | ∘ | 6 | ∘ |
| Ex. 11 | 90/0/10 | PI | 118 | 70 | ∘ | 7 | ∘ |
| Ex. 12 | 90/0/10 | PI | 120 | 57 | ∘ | 5 | ∘ |
| Ex. 13 | 90/0/10 | PI | 122 | 58 | ∘ | 7 | ∘ |
| Ex. 14 | 90/0/10 | PAI | 101 | 61 | ∘ | 5 | ∘ |
| Ex. 15 | 90/0/10 | PAI | 102 | 57 | ∘ | 6 | ∘ |
| Ex. 16 | 90/0/10 | PAI | 104 | 58 | ∘ | 6 | ∘ |
| Ex. 17 | 90/0/10 | PAI | 105 | 56 | ∘ | 7 | ∘ |
| Ex. 18 | 90/0/10 | PAI | 106 | 57 | ∘ | 7 | ∘ |
| Ex. 19 | 90/0/10 | PAI | 109 | 58 | ∘ | 8 | ∘ |
| Ex. 20 | 90/0/10 | PAI | 110 | 64 | ∘ | 5 | ∘ |
| Ex. 21 | 90/0/10 | PAI | 111 | 63 | ∘ | 6 | ∘ |
| Ex. 22 | 90/0/10 | PAI | 115 | 64 | ∘ | 5 | ∘ |
| Ex. 23 | 90/0/10 | PAI | 116 | 67 | ∘ | 7 | ∘ |
| Ex. 24 | 90/0/10 | PAI | 118 | 68 | ∘ | 5 | ∘ |
| Ex. 25 | 90/0/10 | PAI | 120 | 60 | ∘ | 5 | ∘ |
| Ex. 26 | 90/0/10 | PAI | 122 | 58 | ∘ | 6 | ∘ |

TABLE 2

| | Negative | | | Cycle characteristic | | | |
|---|---|---|---|---|---|---|---|
| | electrode | | | at 60° C. | | | |
| | active | Binder | Conju- | Retention | | Expansion | |
| | material | for | gated | ratio | | ratio | |
| | Si/SiOₓ/C | negative | carbonyl | | Judg- | | Judg- |
| Example | (mass ratio) | electrode | compound | % | ment | % | ment |
| Ex. 27 | 29/61/10 | PI | 101 | 62 | ∘ | 5 | ∘ |
| Ex. 28 | 29/61/10 | PI | 102 | 61 | ∘ | 5 | ∘ |
| Ex. 29 | 29/61/10 | PI | 104 | 62 | ∘ | 6 | ∘ |
| Ex. 30 | 29/61/10 | PI | 105 | 64 | ∘ | 6 | ∘ |
| Ex. 31 | 29/61/10 | PI | 106 | 63 | ∘ | 7 | ∘ |
| Ex. 32 | 29/61/10 | PI | 109 | 61 | ∘ | 7 | ∘ |
| Ex. 33 | 29/61/10 | PI | 110 | 62 | ∘ | 7 | ∘ |
| Ex. 34 | 29/61/10 | PI | 111 | 68 | ∘ | 5 | ∘ |
| Ex. 35 | 29/61/10 | PI | 115 | 64 | ∘ | 6 | ∘ |
| Ex. 36 | 29/61/10 | PI | 116 | 67 | ∘ | 5 | ∘ |
| Ex. 37 | 29/61/10 | PI | 118 | 67 | ∘ | 7 | ∘ |
| Ex. 38 | 29/61/10 | PI | 120 | 71 | ∘ | 7 | ∘ |
| Ex. 39 | 29/61/10 | PI | 122 | 70 | ∘ | 6 | ∘ |
| Ex. 40 | 29/61/10 | PAI | 101 | 71 | ∘ | 5 | ∘ |
| Ex. 41 | 29/61/10 | PAI | 102 | 73 | ∘ | 4 | ∘ |
| Ex. 42 | 29/61/10 | PAI | 104 | 74 | ∘ | 6 | ∘ |
| Ex. 43 | 29/61/10 | PAI | 105 | 72 | ∘ | 6 | ∘ |
| Ex. 44 | 29/61/10 | PAI | 106 | 70 | ∘ | 7 | ∘ |
| Ex. 45 | 29/61/10 | PAI | 109 | 76 | ∘ | 7 | ∘ |
| Ex. 46 | 29/61/10 | PAI | 110 | 77 | ∘ | 6 | ∘ |
| Ex. 47 | 29/61/10 | PAI | 111 | 75 | ∘ | 4 | ∘ |
| Ex. 48 | 29/61/10 | PAI | 115 | 74 | ∘ | 5 | ∘ |
| Ex. 49 | 29/61/10 | PAI | 116 | 72 | ∘ | 5 | ∘ |
| Ex. 50 | 29/61/10 | PAI | 118 | 74 | ∘ | 6 | ∘ |
| Ex. 51 | 29/61/10 | PAI | 120 | 73 | ∘ | 7 | ∘ |
| Ex. 52 | 29/61/10 | PAI | 122 | 72 | ∘ | 6 | ∘ |

TABLE 3

| | Negative | | | Cycle characteristic | | | |
|---|---|---|---|---|---|---|---|
| | electrode | | | at 60° C. | | | |
| | active | Binder | Conju- | Retention | | | |
| | material | for | gated | ratio | | | |
| | Si/SiOₓ/C | negative | carbonyl | | Judg- | | Judg- |
| Example | (mass ratio) | electrode | compound | % | ment | % | ment |
| Comp- | 90/0/10 | PI | None | 41 | Δ | 23 | x |
| Ex. 1 | | | | | | | |
| Comp- | 90/0/10 | PAI | None | 40 | Δ | 19 | Δ |
| Ex. 2 | | | | | | | |
| Comp- | 29/61/10 | PI | None | 42 | Δ | 24 | x |
| Ex. 3 | | | | | | | |
| Comp- | 29/61/10 | PAI | None | 42 | Δ | 27 | x |
| Ex. 4 | | | | | | | |

### REFERENCE EXAMPLES

The conjugated carbonyl compound can be synthesized by, for example, as follows.

### Synthesis Example 1

In accordance with the following synthesis scheme (13), the conjugated carbonyl compound represented by the above formula (110) was synthesized.

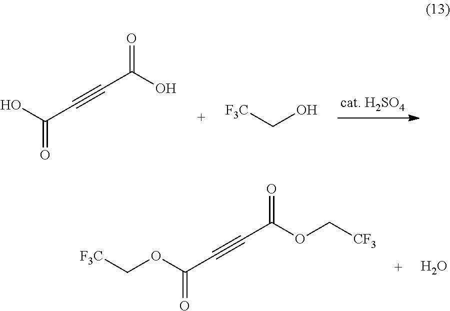 [SMILES: O=C(O)C#CC(=O)O ; OCC(F)(F)F ; O=C(C#CC(=O)OCC(F)(F)F)OCC(F)(F)F ; O]

To a 500 mL three-necked flask equipped with a calcium chloride tube, 175 mL (87.7 mmol) of 2,2,2-trifluoroethanol, 10 g (1.75 mol) of acetylene dicarboxylic acid, and 5 mL of concentrated sulfuric acid were added under an argon atmosphere. After stirring the resultant at room temperature for 4 days, 100 mL of water was added thereto to dilute the sulfuric acid, and sodium hydrogencarbonate was further added thereto to neutralize a sulfuric acid component. After extracting an organic component from the aqueous layer with chloroform, the resultant was dried over magnesium sulfate, and the solvent was distilled off by using an evaporator. The thus obtained mixture was purified by silica gel column chromatography, so as to obtain the compound of the above formula (110) in a yield of 54%. ¹H NMR (ppm): 4.68 (4H, t)

### Synthesis Example 2

The compound of the above formula (109) was obtained in a yield of 60% by substantially the same process performed in the same manner as in Synthesis Example 1 in accordance with the following synthesis scheme (14) except that 2,2,2-trifluoroethanol was replaced with 2,2-difluoroethanol in an equimolecular amount to 2,2,2-trifluoroethanol. ¹H NMR (ppm): 4.52 (4H, m), 5.82 (2H, t)

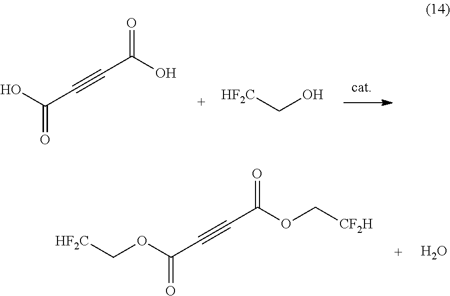

### Synthesis Example 3

The compound of the above formula (112) was obtained in a yield of 64% by substantially the same process performed in the same manner as in Synthesis Example 1 in accordance with the following synthesis scheme (15) except that 2,2,2-trifluoroethanol was replaced with 2-cyanoethanol in an equimolecular amount to 2,2,2-trifluoroethanol. ¹H NMR (ppm): 4.52 (4H, m), 5.75 (2H, t)

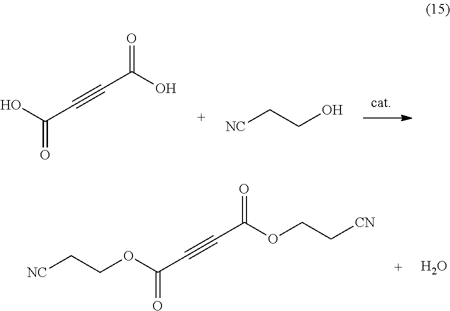 [SMILES: O=C(O)C#CC(=O)O ; N#CCCO ; N#CCCOC(=O)C#CC(=O)OCCC#N ; O]

### Synthesis Example 4

The compound of the above formula (115) was obtained in a yield of 61% by substantially the same process performed in the same manner as in Synthesis Example 1 in accordance with the following synthesis scheme (16) except that 2,2,2-trifluoroethanol was replaced with 2-cyanophenol in an equimolecular amount to 2,2,2-trifluoroethanol. ¹H NMR (ppm): 7.3-7.4 (8H, m)

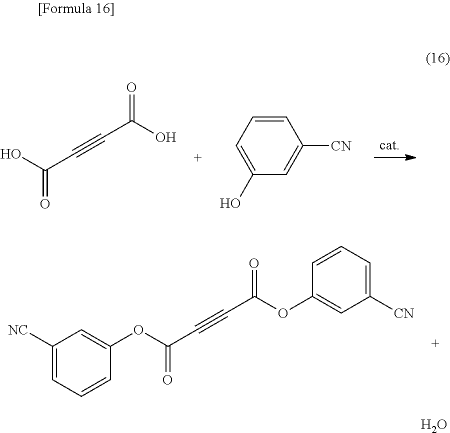 [SMILES: O=C(O)C#CC(=O)O ; N#Cc1cccc(O)c1 ; N#Cc1cccc(OC(=O)C#CC(=O)Oc2cccc(C#N)c2)c1 ; O]

### Synthesis Example 5

The compound of the above formula (118) was obtained in a yield of 62% by substantially the same process performed in the same manner as in Synthesis Example 1 in accordance with the following synthesis scheme (17) except that 2,2,2-trifluoroethanol was replaced with 2-diethylaminoethanol in an equimolecular amount to 2,2,2-trifluoroethanol. ¹H NMR (ppm): 1.13 (12H, t), 2.41 (8H, q), 5.23 (4H, s)

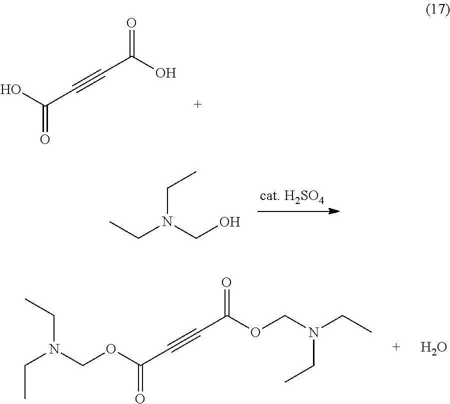

### Synthesis Example 6

The compound of the above formula (121) was obtained in a yield of 66% by substantially the same process performed in the same manner as in Synthesis Example 1 in accordance with the following synthesis scheme (18) except that 2,2,2-trifluoroethanol was replaced with ethylene glycol monomethyl ether in an equimolecular amount to 2,2,2-trifluoroethanol. ¹H NMR (ppm): 3.24 (6H, s), 3.65 (4H, t), 4.33 (4H, t)

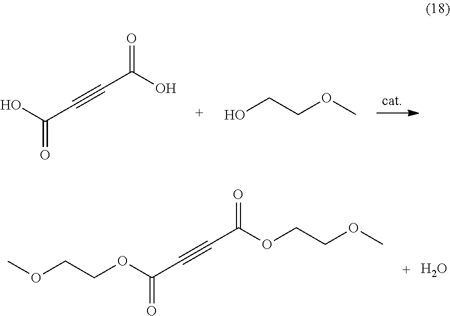

### Synthesis Example 7

The compound of the above formula (123) was obtained in a yield of 70% by substantially the same process performed in the same manner as in Synthesis Example 1 in accordance with the following synthesis scheme (19) except that 2,2,2-trifluoroethanol was replaced with diethylene glycol monomethyl ether in an equimolecular amount to 2,2,2-trifluoroethanol. ¹H NMR (ppm) 3.24 (6H, s), 3.4-3.6 (12H, m), 4.35 (4H, t)

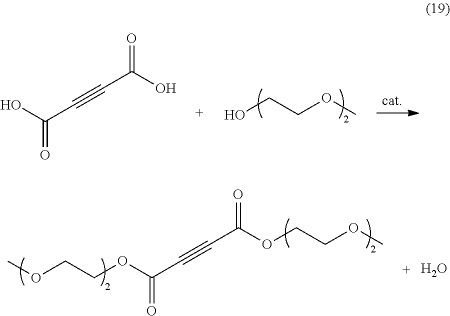

### Synthesis Example 8

The compound of the above formula (125) was obtained in a yield of 60% by substantially the same process performed in the same manner as in Synthesis Example 1 in accordance with the following synthesis scheme (20) except that 2,2,2-trifluoroethanol was replaced with triethylene glycol monomethyl ether in an equimolecular amount to 2,2,2-trifluoroethanol. ¹H NMR (ppm): 3.24 (6H, 5), 3.4-3.6 (20H, m), 4.35 (4H, t)

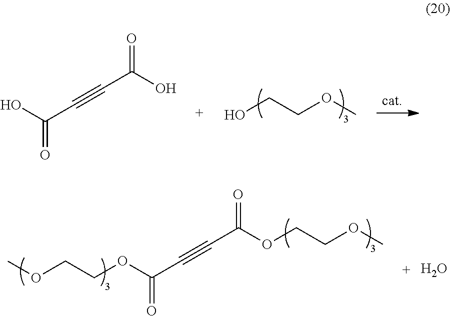

### Synthesis Example 9

The compound of the above formula (127) was obtained in a yield of 65% by substantially the same process performed in the same manner as in Synthesis Example 1 in accordance with the following synthesis scheme (21) except that 2,2,2-trifluoroethanol was replaced with tetraethylene glycol monomethyl ether in an equimolecular amount to 2,2,2-trifluoroethanol. ¹H NMR (ppm): 3.24 (6H, s), 3.4-3.6 (28H, m), 4.35 (4H, t)

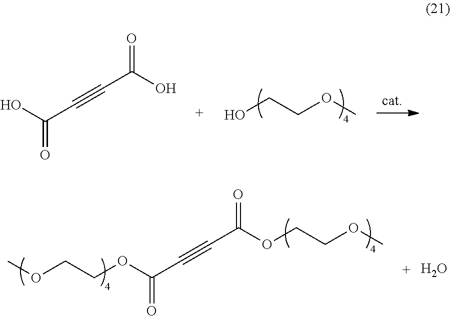

The compounds of formulas (104), (105), (106), (111), (120) and (122) were similarly obtained.

### INDUSTRIAL APPLICABILITY

The present embodiment can be utilized in, for example, all the industrial fields requiring a power supply and the industrial fields pertaining to the transportation, storage and supply of electric energy. Specifically, it can be used in, for example, power supplies for mobile equipment such as cellular phones and notebook personal computers; power supplies for moving/transporting media such as trains, satellites and submarines including electrically driven vehicles such as an electric vehicle, a hybrid vehicle, an electric motorbike, and an electric-assisted bike; backup power supplies for UPSs; and electricity storage facilities for storing electric power generated by photovoltaic power generation, wind power generation and the like.

### EXPLANATION OF SYMBOLS

a: negative electrode
b: separator
c: positive electrode
d: negative electrode collector
e: positive electrode collector
f: positive electrode terminal
g: negative electrode terminal

1. A nonaqueous electrolyte solution for a lithium secondary battery having a negative electrode active material containing element silicon, the nonaqueous electrolyte solution comprising a nonaqueous solvent; an electrolyte salt dissolved in the nonaqueous solvent; and a conjugated carbonyl compound represented by the following formula (1): 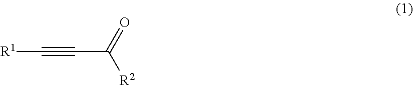
wherein
R¹ represents R^{2a} or —CO—R^{2a}, R^{2a} having a meaning given for R², and
R² represents a hydrogen atom, a substituted or unsubstituted acyl group, a substituted or unsubstituted alkyl group, a cycloalkyl group, an alkenyl group, an alkynyl group, a substituted or unsubstituted aromatic group, an oxyalkylene group represented by the following formula (2):
—(R²¹O)ₙ—R²² (2)
wherein R²¹ represents alkylene having 1 to 6 carbon atoms, R²² represents a hydrocarbon group having 1 to 12 carbon atoms, and n represents an integer of 1 to 10,
an unsubstituted alkoxy group, a substituted alkoxy group, a cycloalkyloxy group, an alkenyloxy group, an alkynyloxy group, a substituted or unsubstituted aromatic oxy group, or an oxyalkyleneoxy group represented by the following formula (2b):
—O—(R²¹O)ₙ—R²² (2b)
wherein R²¹ represents alkylene having 1 to 6 carbon atoms, R²² represents a hydrocarbon group having 1 to 12 carbon atoms, and n represents an integer of 1 to 10.

2. The nonaqueous electrolyte solution according to claim 1, wherein the conjugated carbonyl compound is represented by the following formula (3): 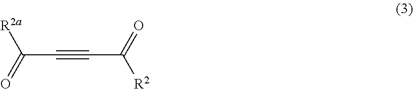
wherein R² and R^{2a} have the same meanings as defined in the above formula (1).

3. The nonaqueous electrolyte solution according to claim 2, wherein the conjugated carbonyl compound is a compound in which R² and R^{2a} in the above formula (3) are each independently selected from: a substituted or unsubstituted alkyl group, a cycloalkyl group, an alkenyl group, an alkynyl group, a substituted or unsubstituted aromatic group, an oxyalkylene group represented by the following formula (2):
—(R²¹O)ₙ—R²² (2)
wherein R²¹ represents alkylene having 1 to 6 carbon atoms, R²² represents a hydrocarbon group having 1 to 12 carbon atoms, and n represents an integer of 1 to 10,
an unsubstituted alkoxy group, a substituted alkoxy group, a substituted or unsubstituted aromatic oxy group, and an oxyalkyleneoxy group represented by the following formula (2b):
—O—(R²¹O)ₙ—R²² (2b)
wherein R²¹ represents alkylene having 1 to 6 carbon atoms, R²² represents a hydrocarbon group having 1 to 12 carbon atoms, and n represents an integer of 1 to 10.

4. The nonaqueous electrolyte solution according to claim 1, wherein the conjugated carbonyl compound is a compound in which R² and R^{2a} are each independently selected from:
an unsubstituted alkyl group having 1 to 12 carbon atoms;
a substituted alkyl group selected from the group consisting of a fluoroalkyl group, an amino alkyl group having a substituent —NR¹¹R¹² wherein R¹¹ and R¹² each independently represent H or an alkyl group having 1 to 6 carbon atoms, and a cyanoalkyl group;
a substituted or unsubstituted aromatic group selected from the group consisting of an aryl group, an aryl alkyl group and an alkyl aryl group, which optionally have —CN or halogen as a substituent on an aromatic ring;
an oxyalkylene group represented by the following formula (2):
—(R²¹O)ₙ—R²² (2)
wherein R²¹ represents alkylene having 1 to 6 carbon atoms, R²² represents a hydrocarbon group having 1 to 12 carbon atoms, and n represents an integer of 1 to 10;
an unsubstituted alkoxy group having 1 to 12 carbon atoms;
a substituted alkoxy group selected from the group consisting of a fluoroalkoxy group, an amino alkoxy group having a substituent —NR¹¹R¹² wherein R¹¹ and R¹² each independently represent H or an alkyl group having 1 to 6 carbon atoms, and a cyanoalkoxy group;
a substituted or unsubstituted aromatic oxy group selected from the group consisting of an aryloxy group, an arylalkyloxy group and an alkylaryloxy group, which optionally have —CN or halogen as a substituent on an aromatic ring; and
an oxyalkyleneoxy group represented by the following formula (2):
—O—(R²¹O)ₙ—R²² (2)
wherein R²¹ represents alkylene having 1 to 6 carbon atoms, R²² represents a hydrocarbon group having 1 to 12 carbon atoms, and n represents an integer of 1 to 10.

5. The nonaqueous electrolyte solution according to claim 2, wherein the conjugated carbonyl compound is a compound represented by formula (3) in which R² and R^{2a} are each independently selected from:
an unsubstituted alkoxy group having 1 to 12 carbon atoms;
a substituted alkoxy group selected from the group consisting of a fluoroalkoxy group, an amino alkoxy group having a substituent —NR¹¹R¹² wherein R¹¹ and R¹² each independently represent H or an alkyl group having 1 to 6 carbon atoms, and a cyanoalkoxy group;
a substituted or unsubstituted aromatic oxy group selected from the group consisting of an aryloxy group, an aryl alkyloxy group and an alkyl aryloxy group, which optionally have —CN or halogen as a substituent on an aromatic ring; and
an oxyalkyleneoxy group represented by the following formula (2):
—O—(R²¹O)ₙ—R²² (2)
wherein R²¹ represents alkylene having 1 to 6 carbon atoms, R²² represents a hydrocarbon group having 1 to 12 carbon atoms, and n represents an integer of 1 to 10.

6. The nonaqueous electrolyte solution according to claim 1, wherein a content of the conjugated carbonyl compound in the nonaqueous electrolyte solution is 0.1 to 2 wt %.

7. A secondary battery comprising an electrode element including a positive electrode and a negative electrode opposing to each other, and an electrolyte solution,
wherein the negative electrode active material contains element silicon, and the electrolyte solution is the nonaqueous electrolyte solution according to claim 1.

8. The secondary battery according to claim 7, wherein the negative electrode active material is a silicon/silicon oxide/carbon complex containing silicon, a silicon oxide and a carbon material.

9. The secondary battery according to claim 8, wherein the whole or a part of the silicon is dispersed in the silicon oxide.

10. The secondary battery according to claim 8, wherein the whole or a part of the silicon has an amorphous structure.

11. The secondary battery according to claim 7, wherein the negative electrode is prepared by binding the negative electrode active material to a negative electrode collector with a binder for negative electrode, and the binder for negative electrode is polyimide or polyamide-imide.

12. The secondary battery according to claim 7, comprising an outer package housing at least the negative electrode and the electrolyte solution, wherein the outer package is a laminated film.

13. The secondary battery according to claim 12, wherein the battery is a laminated type having an electrode element in which the negative electrode and the positive electrode are laminated with separator sandwiched therebetween.

14. An assembled battery using the secondary battery according to claim 7.

15. (canceled)
